(19) United States
(12) Patent Application Publication
(10) Pub. No.: US 2024/0265546 A1
(43) Pub. Date: Aug. 8, 2024

(54) ANALYSIS DEVICE, ANALYSIS METHOD, AND PROGRAM

(71) Applicant: NIPPON TELEGRAPH AND TELEPHONE CORPORATION, Tokyo (JP)

(72) Inventors: Issei WAKUI, Tokyo (JP); Yasuhiro MATSUMOTO, Tokyo (JP)

(73) Assignee: NIPPON TELEGRAPH AND TELEPHONE CORPORATION, Tokyo (JP)

(21) Appl. No.: 18/565,897

(22) PCT Filed: Jun. 2, 2021
(86) PCT No.: PCT/JP2021/021085

§ 371 Date: Nov. 30, 2023

(51) Int. Cl. G06T 7/11; G01S 17/894

(52) U.S. Cl. CPC G06T 7/11; G01S 17/894; G06T 2207/10028

(57) ABSTRACT

An analysis device (1) according to the present invention includes a 3D point cloud data input unit (12) that receives point cloud data inside a structure measured by a laser scanner, a first analysis unit (13) that removes point cloud data other than that of a structure evaluation object from the point cloud data, and a second analysis unit (14) that extracts point cloud data of a place necessary for structure evaluation.

### TECHNICAL FIELD

The present disclosure relates to an analysis device, an analysis method, and a program for improving the accuracy of point cloud data.

### BACKGROUND ART

Conventionally, point cloud data having three-dimensional coordinate values is utilized to predict deterioration in a conduit (particularly, a conduit having a diameter in which a person can stand for laying, removing, and maintenance operations among dedicated conduit tunnels such as that of a communication cable). Point cloud data is data of a set of points handled by a computer and having information such as basic position information of X, Y, and Z and colors. Conventionally, the following three methods and the like have been performed to obtain position coordinates of point cloud data.

The first method is a method in which a laser scanner outputs acquired data as colored point cloud data, and the position of the point cloud data is automatically corrected by simultaneous localization and mapping (SLAM). The point cloud data is acquired by reading information obtained when a laser beam emitted from a laser scanner reaches an object and is reflected. For example, NPL 1 describes a method of inspecting a concrete structure utilizing efficient three-dimensional point cloud data, and NPL 2 describes catalog specifications of a compact and highly accurate laser scanner.

The second method is a method of generating position coordinates from an image captured by using a stereo camera using a structure from motion (SEM) technique. To generate high density point cloud data, a “multi-view stereo (MVS)” technique that is a concept of the SFM technique may be used.

The third method is a method of acquiring absolute position coordinates of the inside of a conduit by combining the plan view and the internal structure view of the conduit.

### CITATION LIST

### Non Patent Literature

[NPL 1] Makoto Kameoka et al., “Inspection of concrete structures utilizing point cloud data,” 2020 Japan Society of Civil Engineers National Convention 75th Annual Academic Lecture, VI-270
[NPL 2] FARO Focus laser scanner catalog, [online], [Retrieved May 10, 2021], Internet <URL: https://www.faro.com/ja-JP/Resource-Library/Tech-Sheet/techsheet-faro-focus-laser-scanner>

### SUMMARY OF INVENTION

### Technical Problem

However, in order to predict deterioration by evaluating the structure of a conduit, it is necessary to reduce errors of position information of point cloud data in the conduit and perform finite element method (FEM) analysis or the like. For example, an allowable amount of displacement itself is 1/500 of a tunnel diameter, and an allowable amount of about 6 mm is required when the diameter is 3 m. Since a soil pressure has already been applied and a remaining allowable displacement is several mm, displacement measurement in unit of mm is required, but displacement of a diameter remains at an accuracy of +2 mm even with the maximum accuracy in a point cloud scanner.

Further, there are non-coincident places in position information of a plan view, a longitudinal view, and an internal structure view of a conduit, and the plan view, the longitudinal view, and the internal structure view of the conduit have places which do not match a local structure, and thus it is difficult to evaluate the structure using drawing position information according to combination of the plan view and the internal structure view of the conduit.

On the other hand, although the accuracy of position information of point cloud data acquired by a high-accuracy laser scanner is high (maximum accuracy of +1.0 mm), most of the point cloud data stands still to be measured, and thus it takes time to measure a wide range and a long section such as a conduit and the measurement cost increases.

An object of the present invention, which has been made in view of such circumstances, is to establish a technique for improving the accuracy of point cloud data for structure evaluation in analysis of an internal image and point cloud data of a structure.

### Solution to Problem

In order to achieve the aforementioned object, an analysis device according to an embodiment is an analysis device for generating point cloud data of a structure evaluation object, including a 3D point cloud data input unit configured to receive point cloud data of a structure evaluation target area measured by a laser scanner, a first analysis unit configured to remove point cloud data other than that of the structure evaluation object from the point cloud data, and a second analysis unit configured to extract point cloud data of a place necessary for structure evaluation from the point cloud data removed by the first analysis unit.

In order to achieve the aforementioned object, an analysis method according to an embodiment is an analysis method in an analysis device for generating point cloud data of a structure evaluation object, the analysis method including, using the analysis device, an input step of receiving point cloud data of a structure evaluation target area measured by a laser scanner, a removal step of removing point cloud data other that of than the structure evaluation object from the point cloud data, and a step of extracting point cloud data of a place necessary for structure evaluation from the point cloud data removed in the removal step.

In order to achieve the aforementioned object, a program according to an embodiment causes a computer to serve as the above-described analysis device.

### Advantageous Effects of Invention

According to the present disclosure, it is possible to improve the accuracy of point cloud data for structure evaluation.

### BRIEF DESCRIPTION OF DRAWINGS

FIG. 1 is a block diagram showing an example of a configuration of an analysis device according to an embodiment.

FIG. 2A is a schematic diagram identifying a point cloud data region to be removed other than that of a structure evaluation object.

FIG. 2B is a schematic diagram showing a criterion for identifying a point cloud data surface to be removed other than that of a structure evaluation object.

FIG. 3 is a schematic diagram illustrating a method of extracting point cloud data at a place necessary for structural analysis.

FIG. 4 is a flowchart showing an example of an analysis method executed by the analysis device according to an embodiment.

FIG. 5 is a block diagram showing a schematic configuration of a computer serving as the analysis device.

### DESCRIPTION OF EMBODIMENTS

Hereinafter, an analysis device according to an embodiment will be described in detail. The present invention is not limited to the embodiment below and can be modified in various manners without departing from the scope of the gist of the invention.

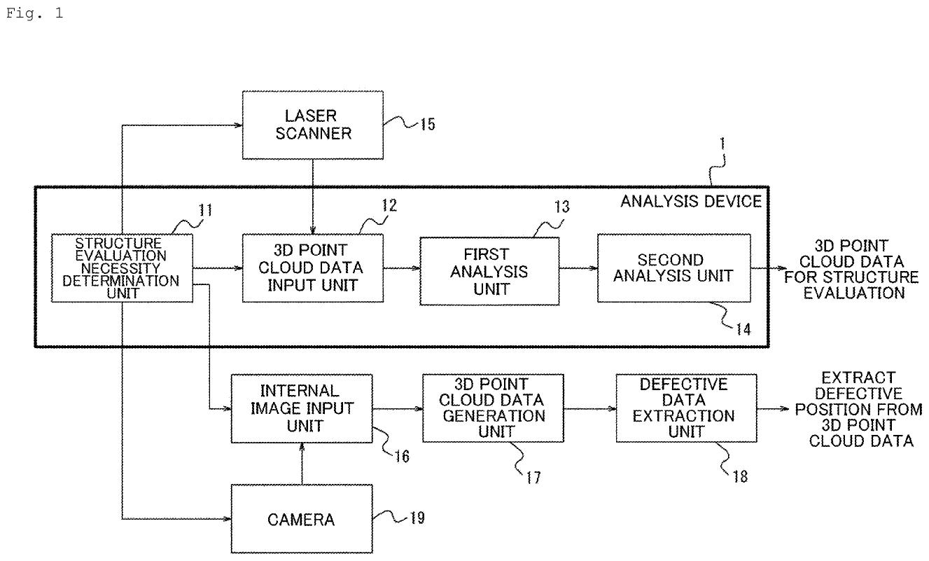

As shown in in FIG. 1, the analysis device 1 according to an embodiment includes a structure evaluation necessity determination unit 11, a 3D point cloud data input unit 12, a first analysis unit 13, and a second analysis unit 14. The analysis device 1 generates point cloud data of a structure evaluation object.

The structure evaluation necessity determination unit 11 determines whether or not a structure is a structure evaluation target area requiring structure evaluation on the basis of data of a cross-sectional line shape of the structure. The structure evaluation target area is a place where stress is applied by vibration over time, such as a connection part between a shaft and a tunnel and a connection part between a building and a tunnel. For example, the structure evaluation necessity determination unit 11 regards a place whose shape is changed as compared to other places as a structure evaluation target area and selects it using data of a cross-sectional line shape described in any of a plan view, a longitudinal view, and an internal structure view of the structure. The structure evaluation necessity determination unit 11 outputs a determination result to the 3D point cloud data input unit 12. The structure evaluation necessity determination unit 11 may determine whether or not structure evaluation is necessary manually by an operator looking around a position for performing structure evaluation, or may realize a functional unit that automatically determines whether or not structure evaluation is necessary by reading data by which a place in a drawing of a tunnel can be recognized. Although the structure evaluation target area is described as a tunnel internal structure below in the present embodiment, the structure evaluation target area is not limited thereto.

The 3D point cloud data input unit 12 receives point cloud data (3D point cloud data) of the structure target area measured by a laser scanner 15 when the structure evaluation necessity determination unit 11 determines the structure as the structure evaluation target area and outputs the point cloud data to the first analysis unit 13.

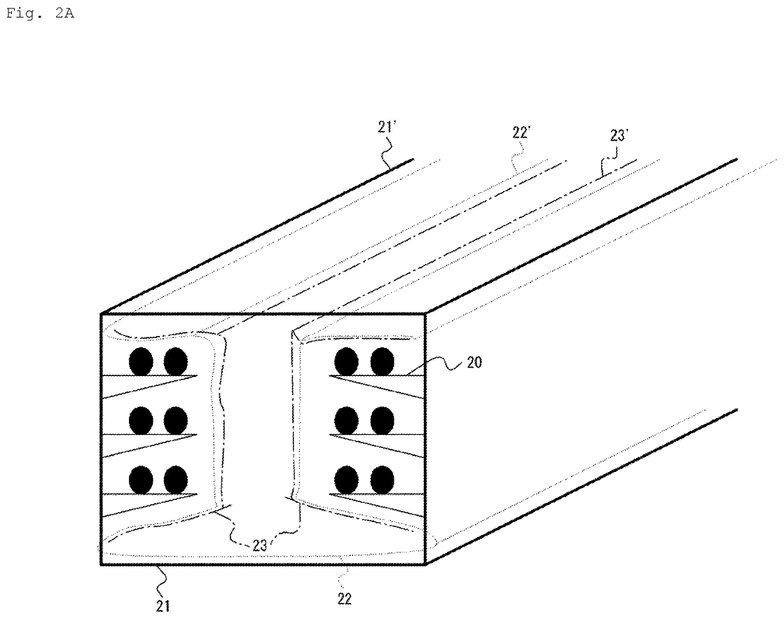

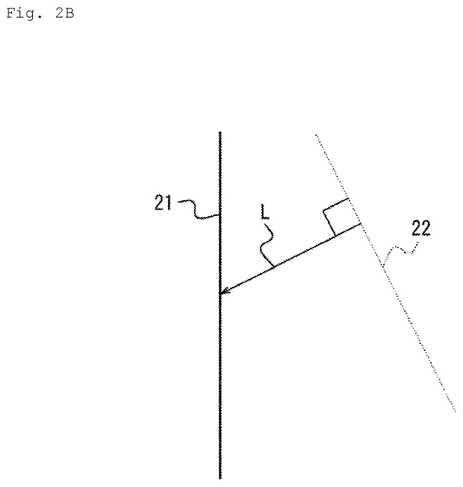

The first analysis unit 13 removes point cloud data other than that of the structure evaluation object from the 3D point cloud data and outputs the point cloud data from which the point cloud data other than that of the structure evaluation object has been removed to the second analysis unit. A method of removing point cloud data other than that of a deterioration prediction object will be described in detail below with reference to FIGS. 2A and 2B.

The first analysis unit 13 identifies accessories other than the structure evaluation object and removes point cloud data of the accessories in removing the point cloud data other than that of the structure evaluation object. When the structure evaluation target area is a tunnel internal structure, the accessories are hardware, a cable, and the like installed inside the tunnel.

For example, the first analysis unit 13 identifies a point cloud data surface in which the length of a normal line between the 2D internal cross section of the structure and the point cloud data surface is equal to or longer than a predetermined length and removes an area obtained by extending the identified point cloud data surface in the traveling direction of the structure. This processing will be described with reference to FIG. 2. Although a structure evaluation target area is described below as a tunnel internal structure in FIG. 2, a deterioration prediction target is not limited thereto.

FIG. 2A is a schematic diagram identifying a point cloud data area to be removed other than that of a structure evaluation object. In FIG. 2A, a solid line represents a 2D internal cross section 21 of the tunnel and a region 21′ obtained by extending the internal cross section 21 in the direction in which the tunnel extends, a broken line represents a 2D point cloud data surface 22 generated by a laser scanner and a region 22′ obtained by extending the point cloud data surface 22 in the direction in which the tunnel extends, a dashed line represents a 2D point cloud data surface 23 to be removed and a point cloud data region 23′ to be removed obtained by extending the point cloud data surface 23 to be removed in the direction in which the tunnel extends, and black circles and triangles represent accessories (black circles are cables and triangles are hardware).

FIG. 2B is a schematic diagram showing a criterion for identifying a point cloud data surface to be removed other than that of the structure evaluation object. Specifically, as shown in FIG. 2B, the first analysis unit 13 determines whether or not the length of a normal line L extending to the 2D internal cross section 21 of the tunnel from the point cloud data surface 22 at a right angle is equal to or longer than a predetermined length in the 2D internal cross section of the tunnel. When the length of the normal line L is equal to or longer than the predetermined length, the first analysis unit 13 determines that the 2D internal cross section 21 of the tunnel and the point cloud data surface 22 are largely separated, identifies the point cloud data surface 23 to be removed in the 2D internal cross section 21 of the tunnel, as shown in FIG. 2A, extends the point cloud data surface 23 in the direction in which the tunnel extends, and identifies the 3D point cloud data region 23′ to be removed.

Further, the first analysis unit 13 may estimate the cross-sectional line shape of the structure evaluation object hidden by accessories (cable, hardware 20, and the like shown in FIG. 2B) installed inside the structure evaluation target area from the cross-sectional line shape of the 3D point cloud data and remove a region obtained by extending the estimated cross-sectional line shape in the direction in which the structure extends.

The second analysis unit 14 is a functional unit for extracting point cloud data of a place necessary for structure evaluation from the point cloud data removed by the first analysis unit 13.

The second analysis unit 14 identifies a place necessary for structure evaluation such as FEM analysis in extracting point cloud data of a place necessary for structure evaluation. A specific extraction method will be described below.

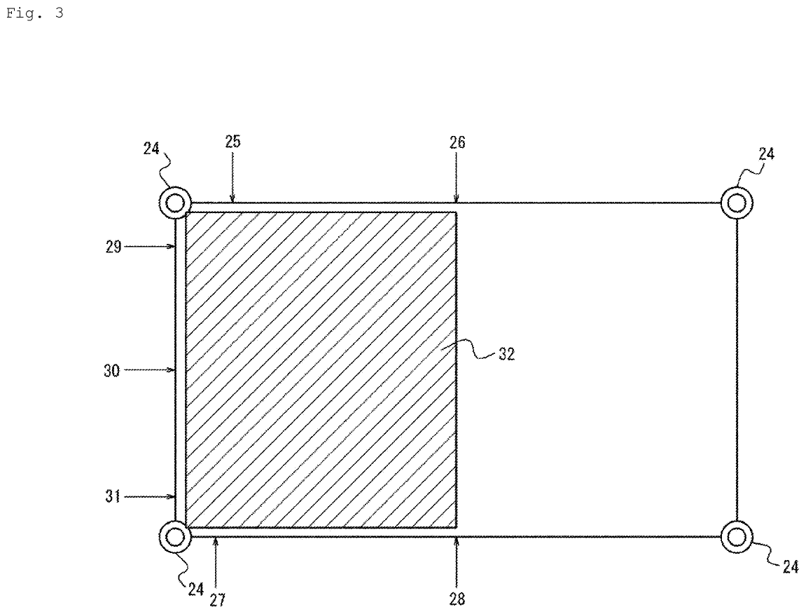

FIG. 3 is a schematic diagram illustrating a method of extracting point cloud data at a place necessary for structure analysis when the shape of the 2D internal cross section of the tunnel is square. In the figure, positions such as corner parts 24, an upper floor slab fulcrum 25, an upper floor slab center 26, a side wall upper fulcrum 29, a side wall upper center 30, a side wall lower fulcrum 31, a lower floor slab fulcrum 27, and a lower floor slab center 28 are specified on the rectangular 2D internal cross section of the tunnel in order to smoothly perform the following description.

A specific method of identifying a 3D point cloud data surface to be extracted is as follows. First, a center point among three points at which an angle connecting arbitrary three points of the tunnel 2D internal cross section on a tunnel internal image becomes 90 degrees is identified as a vertex of the tunnel 2D internal cross section. Next, the second analysis unit 14 plots the four vertexes on point cloud data acquired by a laser scanner, divides the tunnel 2D internal cross section surrounded by the four vertexes into two in a floor slab direction, and extracts point cloud data included in an area 32 (2D internal cross section divided into two in the floor slab direction) represented by oblique lines. The reason why the data is limited to the point cloud data included in the area 32 is that a data range to be input at the time of performing FEM analysis or the like is half the floor direction. Subsequently, a 3D point cloud data region to be extracted is identified by extending the point cloud data in the direction in which the tunnel extends, and point cloud data of a place necessary for structure evaluation is extracted. That is, as shown in FIG. 3, the second analysis unit 14 identifies the 3D point cloud data region to be extracted and extracts point cloud data included in the region by extending the 2D internal cross section obtained by dividing the rectangular 2D internal cross section of the tunnel (structure) into two in the floor slab direction by a line connecting the upper floor slab center 26 and the lower floor slab center 28 in the direction in which the tunnel (structure) extends.

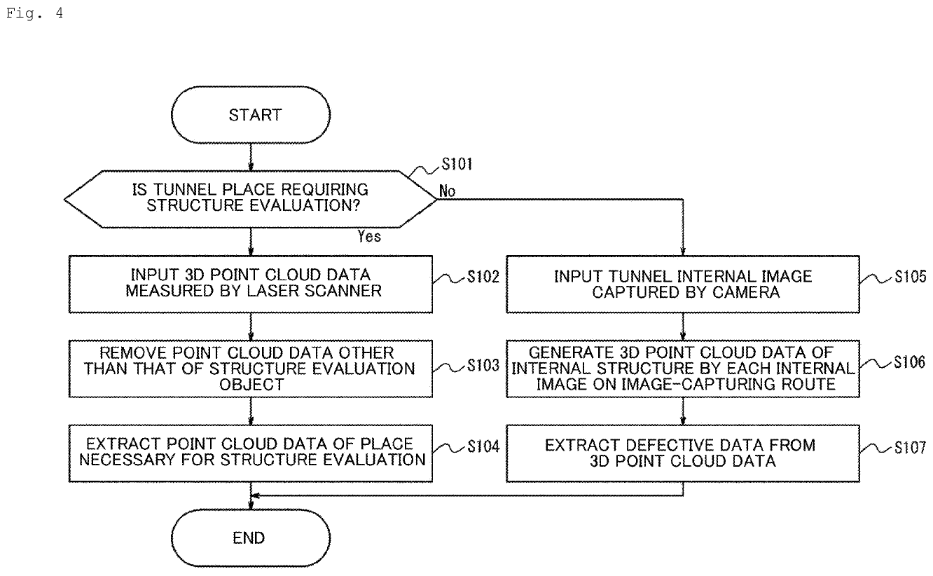

FIG. 4 is a flowchart showing an example of an analysis method executed by the analysis device 1 according to a first embodiment.

In step S101, the structure evaluation necessity determination unit 11 determines whether or not a tunnel (structure) corresponds to a structure evaluation target area requiring structure evaluation.

When the structure evaluation necessity determination unit 11 determines that the tunnel corresponds to a structure evaluation target area, the analysis device 1 executes steps S102 to S105.

In step S102, the 3D point cloud data input unit receives point cloud data (3D point cloud data) of the structure target area measured by the laser scanner 15.

In step S103, the first analysis unit 13 removes point cloud data other than that of a structure evaluation object from the 3D point cloud data.

In step S104, the second analysis unit 14 extracts point cloud data of a place necessary for structure evaluation.

On the other hand, when the structure evaluation necessity determination unit 11 determines that the tunnel does not correspond to the structure evaluation target area in step S101, as shown in FIG. 4, the analysis device 1 executes steps S105 to S107.

In step S105, the internal image input unit 16 receives an image of the inside of the tunnel captured by a camera.

In step S106, a 3D point cloud data generation unit 17 generates 3D point cloud data of an internal structure by each internal image on an image-capturing route.

In step S107, a defective data extraction unit 18 extracts data at a defective position from the generated 3D point cloud data. Defective data refers to position data of a place which changes as compared to other places, such as a significantly bent tunnel shape.

According to the analysis device 1, the accuracy of point cloud data for structure evaluation can be improved.

The structure evaluation necessity determination unit 11, the 3D point cloud data input unit 12, the first analysis unit 13, and the second analysis unit 14 in the analysis device 1 described above form a part of a control unit (controller). The control arithmetic circuit may be configured by dedicated hardware such as an application specific integrated circuit (ASIC) or a field-programmable gate array (FPGA), may be configured by a processor, or may be configured by including both.

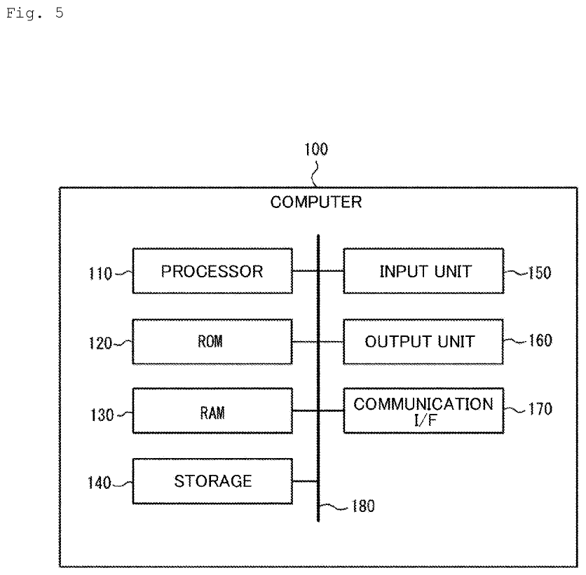

In addition, a computer capable of executing program instructions can be used to serve as the analysis device 1 described above. FIG. 5 is a block diagram showing a schematic configuration of a computer serving as the analysis device 1. Here, the computer 100 may be a general-purpose computer, a dedicated computer, a workstation, a personal computer (PC), an electronic notepad, or the like. The program instructions may be program codes, code segments, or the like for executing necessary tasks.

As shown in FIG. 5, the computer 100 includes a processor 110, a read only memory (ROM) 120, a random access memory (RAM) 130, and a storage 140 as a storage unit, an input unit 150, an output unit 160, and a communication interface (I/F) 170. The components are connected to each other via a bus 180 such that they can communicate.

The ROM 120 stores various programs and various types of data. The RAM 130 is a work area and temporarily stores a program or data. The storage 140 is configured by a hard disk drive (HDD) or a solid state drive (SSD) and stores various programs including an operating system and various types of data. In the present disclosure, the ROM 120 or the storage 140 stores a program according to the present disclosure.

The processor 110 is specifically a central processing unit (CPU), a micro processing unit (MPU), a graphics processing unit (GPU), a digital signal processor (DSP), a system on a chip (SoC), or the like and may be composed of multiple processors of the same type or different types. The processor 110 reads a program from the ROM 120 or the storage 140 and executes the program using the RAM 130 as a work area to perform control of the aforementioned components and various types of arithmetic processing. At least a part of these processing contents may be realized by the hardware.

The program may also be recorded on a recording medium readable by the computer 100. Using such a recording medium, it is possible to install the program in the computer 100. Here, the recording medium on which the program is recorded may be a non-transitory recording medium. Although not particularly limited, the non-transitory recording medium may be a CD-ROM, a DVD-ROM, a Universal Serial Bus (USB) memory, or the like, for example. Further, this program may be downloaded from an external device via a network.

The following additional remarks are disclosed in relation to the embodiments described above.

### (Supplement 1)

An analysis device for generating point cloud data of a structure evaluation object, including a control unit configured to receive point cloud data of a structure evaluation target area measured by a laser scanner, to remove point cloud data other than that of the structure evaluation object from the point cloud data, and to extract point cloud data of a place necessary for structure evaluation from the point cloud data removed by a first analysis unit.

### (Supplement 2)

The analysis device according to the supplement 1, wherein the control unit identifies a point cloud data surface in which a length of a normal line between a 2D internal cross section of a structure and the point cloud data surface is equal to or longer than a predetermined length and removes a region obtained by extending the identified point cloud data surface in a direction in which the structure extends.

### (Supplement 3)

The analysis device according to the supplement 1, wherein the control unit estimates a cross-sectional line shape of the structural evaluation object hidden by accessories installed inside the structure evaluation target area from a cross-sectional line shape of the point cloud data and removes a region obtained by extending the estimated cross-sectional line shape in the direction in which the structure extends.

### (Supplement 4)

The analysis device according to any one of the supplements 1 to 3, wherein
the control unit identifies a place necessary for structure evaluation such as FEM analysis and extracts point cloud data.

### (Supplement 5)

The analysis device according to the supplement 4, wherein the control unit identifies a 3D point cloud data region to be extracted and extracts point cloud data included in the region by extending a 2D internal cross section, obtained by dividing the 2D internal cross section of the structure into two in a floor slab direction, in the direction in which the structure extends.

### (Supplement 6)

An analysis method in an analysis device for generating point cloud data of a structure evaluation object, the analysis method, using the analysis device, including:
an input step of receiving point cloud data of a structure evaluation target area measured by a laser scanner;
a removal step of removing point cloud data other than that of the structure evaluation object from the point cloud data; and
a step of extracting point cloud data of a place necessary for structure evaluation from the point cloud data removed in the removal step.

### (Supplement 7)

A non-transitory storage medium storing a program executable by a computer, the non-transitory storage medium storing a program causing the computer to serve as the analysis device according to any one of the supplements 1 to 5.

Although the above-described embodiment has been introduced as a typical example, it is clear for a person skilled in the art that many alterations and substitutions are possible within the gist and scope of the present disclosure. Therefore, the present invention should not be interpreted as being limited by the above-described embodiment and can be modified or altered in various ways without departing from the scope of the claims. For example, a plurality of configuration blocks shown in the configuration diagrams of the embodiment may be combined to one, or one configuration block may be divided.

### REFERENCE SIGNS LIST

1 Analysis device
11 Structure evaluation necessity determination unit
12 3D point cloud data input unit
13 First analysis unit
14 Second analysis unit
15 Laser scanner
16 Internal image input unit
17 3D point cloud data generation unit
18 Defective data extraction unit
19 Camera
100 Computer
110 Processor
120 ROM
130 RAM
140 Storage
150 Input unit
160 Output unit
170 Communication interface (I/F)
180 Bus

1. An analysis device for generating point cloud data of a structure evaluation object, the analysis device comprising a processor configured to execute operations comprising:
receiving point cloud data of a structure evaluation target area from a laser scanner device;
removing point cloud data other than that of the structure evaluation object from the point cloud data; and
extracting point cloud data of a place necessary for structure evaluation from the removed point cloud data.

2. The analysis device according to claim 1, wherein the removing further comprises:
identifying a point cloud data surface in which a length of a normal line between a 2D internal cross section of a structure and the point cloud data surface is equal to or longer than a predetermined length, and
removing a region obtained by extending the identified point cloud data surface in a direction in which the structure extends.

3. The analysis device according to claim 1, wherein the removing further comprises:
estimating a cross-sectional line shape of the structure evaluation object hidden by accessories installed inside the structure evaluation target area from a cross-sectional line shape of the point cloud data, and
removing a region obtained by extending the estimated cross-sectional line shape in a direction in which the structure extends.

4. The analysis device according to claim 1, wherein the extracting further comprises:
identifying a place necessary for structure evaluation of finite element method analysis, and
extracting point cloud data.

5. The analysis device according to claim 4, wherein the extracting further comprises:
identifying a 3D point cloud data region to be extracted, and
extracting point cloud data included in the region by extending a 2D internal cross section, obtained by dividing the 2D internal cross section of the structure into two in a floor slab direction, in a direction in which the structure extends.

6. An analysis method for generating point cloud data of a structure evaluation object, comprising:
receiving point cloud data of a structure evaluation target area from a laser scanner device;
removing point cloud data other than that of the structure evaluation object from the point cloud data; and
extracting point cloud data of a place necessary for structure evaluation from the removed point cloud data.

7. A computer-readable non-transitory recording medium storing a computer-executable program instructions that when executed by a processor cause a computer system to execute operations comprising:
receiving point cloud data of a structure evaluation target area from a laser scanner device;
removing point cloud data other than that of the structure evaluation object from the point cloud data; and
extracting point cloud data of a place necessary for structure evaluation from the removed point cloud data.

8. The analysis device according to claim 2, wherein the extracting further comprises:
identifying a place necessary for structure evaluation of finite element method analysis, and
extracting point cloud data.

9. The analysis device according to claim 3, wherein the extracting further comprises:
identifying a place necessary for structure evaluation of finite element method analysis, and
extracting point cloud data.

10. The analysis method according to claim 6, wherein the removing further comprises:
identifying a point cloud data surface in which a length of a normal line between a 2D internal cross section of a structure and the point cloud data surface is equal to or longer than a predetermined length, and
removing a region obtained by extending the identified point cloud data surface in a direction in which the structure extends.

11. The analysis method according to claim 6, wherein the removing further comprises:
estimating a cross-sectional line shape of the structure evaluation object hidden by accessories installed inside the structure evaluation target area from a cross-sectional line shape of the point cloud data, and
removing a region obtained by extending the estimated cross-sectional line shape in a direction in which the structure extends.

12. The analysis method according to claim 6, wherein the extracting further comprises:
identifying a place necessary for structure evaluation of finite element method analysis, and
extracting point cloud data.

13. The analysis method according to claim 12, wherein the extracting further comprises:
identifying a 3D point cloud data region to be extracted, and
extracting point cloud data included in the region by extending a 2D internal cross section, obtained by dividing the 2D internal cross section of the structure into two in a floor slab direction, in a direction in which the structure extends.

14. The analysis method according to claim 10, wherein the extracting further comprises:
identifying a place necessary for structure evaluation of finite element method analysis, and
extracting point cloud data.

15. The analysis method according to claim 11, wherein the extracting further comprises:
identifying a place necessary for structure evaluation of finite element method analysis, and
extracting point cloud data.

16. The computer-readable non-transitory recording medium according to claim 7, wherein the removing further comprises:
identifying a point cloud data surface in which a length of a normal line between a 2D internal cross section of a structure and the point cloud data surface is equal to or longer than a predetermined length, and
removing a region obtained by extending the identified point cloud data surface in a direction in which the structure extends.

17. The computer-readable non-transitory recording medium according to claim 7, wherein the removing further comprises:
estimating a cross-sectional line shape of the structure evaluation object hidden by accessories installed inside the structure evaluation target area from a cross-sectional line shape of the point cloud data, and
removing a region obtained by extending the estimated cross-sectional line shape in a direction in which the structure extends.

18. The computer-readable non-transitory recording medium according to claim 7, wherein the extracting further comprises:
identifying a place necessary for structure evaluation of finite element method analysis, and
extracting point cloud data.

19. The computer-readable non-transitory recording medium according to claim 18, wherein the extracting further comprises:
identifying a 3D point cloud data region to be extracted, and
extracting point cloud data included in the region by extending a 2D internal cross section, obtained by dividing the 2D internal cross section of the structure into two in a floor slab direction, in a direction in which the structure extends.

20. The computer-readable non-transitory recording medium according to claim 16, wherein the extracting further comprises:
identifying a place necessary for structure evaluation of finite element method analysis, and
extracting point cloud data.
